(19) United States
(12) Patent Application Publication
(10) Pub. No.: US 2009/0322111 A1
(43) Pub. Date: Dec. 31, 2009

(54) VEHICLE RACK

(75) Inventors: Christopher E. Fischer, Boulder, CO (US); Daniel A. Estoque, Boulder, CO (US); Jessica L. Fischer, Boulder, CO (US)

Correspondence Address: HOLLAND & HART, LLP, P.O BOX 8749, DENVER, CO, 80201, US

(73) Assignee: BOOMERANG ENTERPRISES, INC., Boulder, CO (US)

(21) Appl. No.: 12/494,560

(22) Filed: Jun. 30, 2009

Related U.S. Application Data
(60) Provisional application No. 61/077,014, filed on Jun. 30, 2008.

(51) Int. Cl. B60P 3/00

(52) U.S. Cl. 296/3

(57) ABSTRACT

A vehicle rack system including a framework including a driver's side portion, a passenger's side portion and a front portion extending therebetween. The driver's side and the passenger's side portions being triangular in configuration and having a lower frame piece for mounting to a side bed of a vehicle and a downwardly sloping upper frame piece. The upper frame pieces of the driver's side portion and the passenger's side portion may diverge in a rearward direction from the front portion. The system includes a covering for providing a sheltered environment for the vehicle's cargo bed. The covering includes driver's side and passenger's side panels that are removably insertable into the side portions. The covering also includes a cover spanning between the driver's side portion and the passenger's side portion. It is contemplated that the driver's side portion may be constructed as a mirror image of the passenger's side portion.

### FIELD

The present invention relates to the field of vehicles, and more particularly concerns accessory items for vehicles. The invention is even more specifically directed to vehicle accessory racks and coverings.

### BACKGROUND

Vehicles with open cargo beds, such as pickup trucks and some SUVs, are generally very versatile and useful for carrying equipment, sporting goods, supplies, and the like. However, one drawback to an open cargo bed is that items carried in the bed of a pickup truck, for instance, are exposed to the elements and are exposed to potential theft. It would be desirable to employ the use of a rack system even on a vehicle with a cargo bed so that items in the bed could be protected while other equipment such as skis, snowboards, and bicycles could be carried outside the cargo area so as not to take up space inside the cargo area.

One means of protecting items in a cargo bed from theft and the elements is a tonneau cover, which is usually a flexible tarp that is stretched across the top of the bed and secured thereto. One drawback of the typical tonneau cover is that it limits the height dimension of the cargo area as it is stretched across the height of the cargo bed walls. A means of protecting a cargo area without excessively limiting the cargo area height is a fiberglass shell, sometimes known as a topper or truck cap. These truck caps are attached to the upper edge of the cargo bed and are generally the same height as the vehicle's cab. The downside of a topper is that it is generally very heavy and is usually considered a permanent installation as it is not easily removable and handled. In both the case of the tonneau cover and truck cap the use of a vehicle rack system for carrying sporting equipment is impractical. In the case of a tonneau cover, the tarp would interfere with typical rack systems that might attach to the side walls of the bed. Here again, a rack system spanning the bed walls would excessively limit cargo space within the bed. In the case of a truck cap, the addition of a rack system to the top of the cap would be at such a height as to be very difficult to load equipment such as bicycles. Furthermore, for some vehicles a topper does not provide enough height to carry a bicycle in the preferred up-right orientation inside the topper.

Accordingly there is a need for a rack system that may be used on vehicles with an open bed that provides a means to carry sporting equipment without taking up space in the cargo area or excessively limiting the cargo area height. Furthermore, there is a need for such a rack system that also provides a means for protecting and securing the contents of the cargo area. Preferably, such a rack system would be of a relative size and weight such that removal and installation would be more convenient than existing truck caps.

### SUMMARY

Provided herein is a vehicle rack system including a framework including a driver's side portion, a passenger's side portion and a front portion extending therebetween. The driver's side portion and the passenger's side portion being triangular in configuration and having a lower frame piece for mounting to a side bed of a vehicle and a downwardly sloping upper frame piece. The upper frame pieces of the driver's side portion and the passenger's side portion may diverge from one another in a rearward direction from the front portion.

The system includes a covering for providing a sheltered environment for the vehicle's cargo bed. The covering includes driver's side and passenger's side panels that are removably insertable into the side portions. The covering also includes a cover spanning between the driver's side portion and the passenger's side portion. It is contemplated that the driver's side portion may be constructed as a mirror image of the passenger's side portion.

The system may also include a cargo mounting system removably mounted to the framework. The cargo mounting system includes a driver's side rail received in a first track formed in the upper frame piece of the driver's side portion and a passenger's side rail received in a second track formed in the upper frame piece of the passenger's side portion. A pair of clamp pieces is associated with each rail, which attach at least one cargo mounting bar at selected positions along the upper frame pieces of the driver's side portion and the passenger's side portion.

In one embodiment the cover could includes a front cover portion and a top cover portion that includes a plurality of cover panels. The top cover portion is at least partially retractable at discrete locations between the driver's side portion and the passenger's side portion.

### BRIEF DESCRIPTION OF THE DRAWINGS

FIG. 1 is a partial left perspective view of a pickup truck supporting a vehicle rack according to an exemplary embodiment;

FIG. 2 is a perspective view as in FIG. 1, but with the vehicle rack's covering removed;

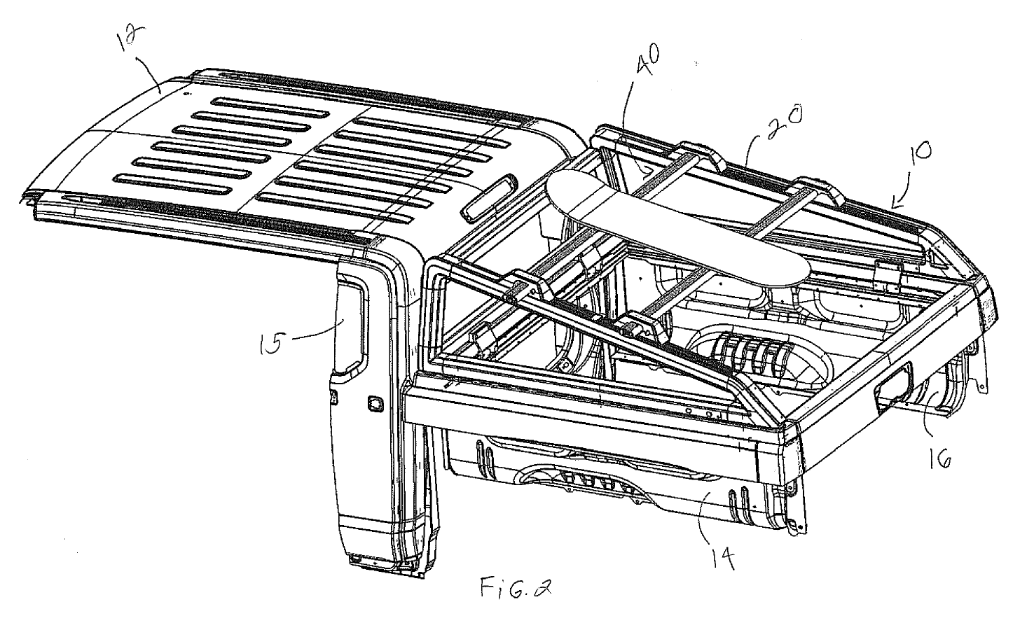

FIG. 3 is an exploded perspective view of the vehicle rack its covering removed, and the covering's left side panel displaced inwardly in a pre-insertion position;

FIG. 4a is a left side view in elevation of the vehicle rack's framework;

FIG. 4b is a right side you in elevation of the framework;

FIG. 4c is a top plan view of the framework;

FIG. 4d is a front view in elevation of the framework;

FIG. 5a is an enlarged partial perspective view showing the interior of the framework's left side portion;

FIG. 5b is an exploded view of the left side portion as illustrated in FIG. 5a;

FIG. 6 is a partial perspective view illustrating a representative cargo mounting system for the framework; and

FIG. 7 is an interior plan view, partially broken away, of the left side panel.

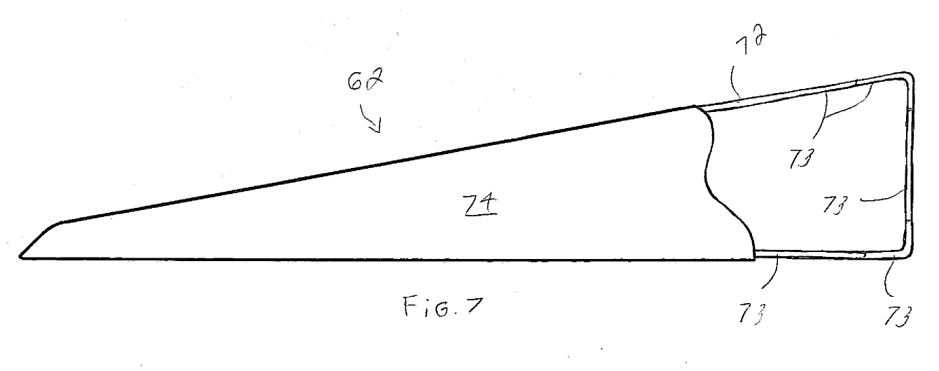

### DETAILED DESCRIPTION

Provided is a vehicle rack which may be selectively used to cover a vehicle and/or to support cargo. To this end, preferred embodiments of the rack described suitably provide a sheltered environment for portions of a vehicle, while permitting a variety of cargo to be transported. While the exemplary embodiments described herein relate to use of the vehicle rack in conjunction with a pickup truck having a cargo bed, the ordinarily skilled artisan will readily appreciate that the inventive concepts herein can be applied to any of a variety of vehicle configurations not limited to pickup trucks. That is, the teachings can be applied to sports utility vehicles, vehicles having hybrid constructions such as those which are convertible between a pickup configuration and an SUV configuration, and indeed any type of vehicle construction which can suitably benefit from the teachings herein, whether commercial, recreational, custom, full-sized, or models of scale. Moreover, while the vehicle rack is described in the exemplary embodiments supporting a snowboard as cargo, any of a variety of cargo types could be transported as well known in the art of vehicle rack systems.

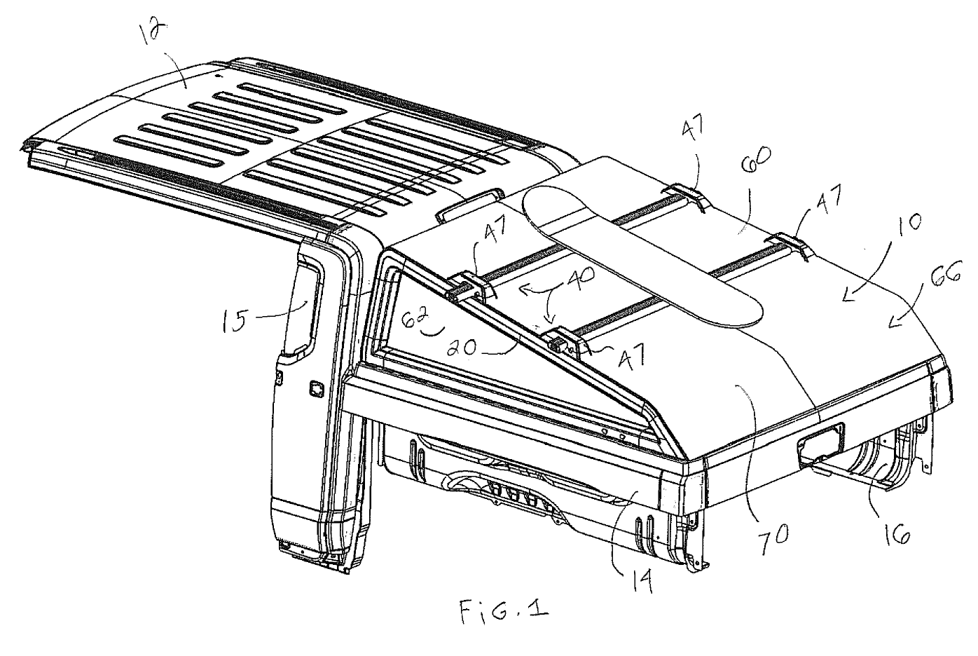

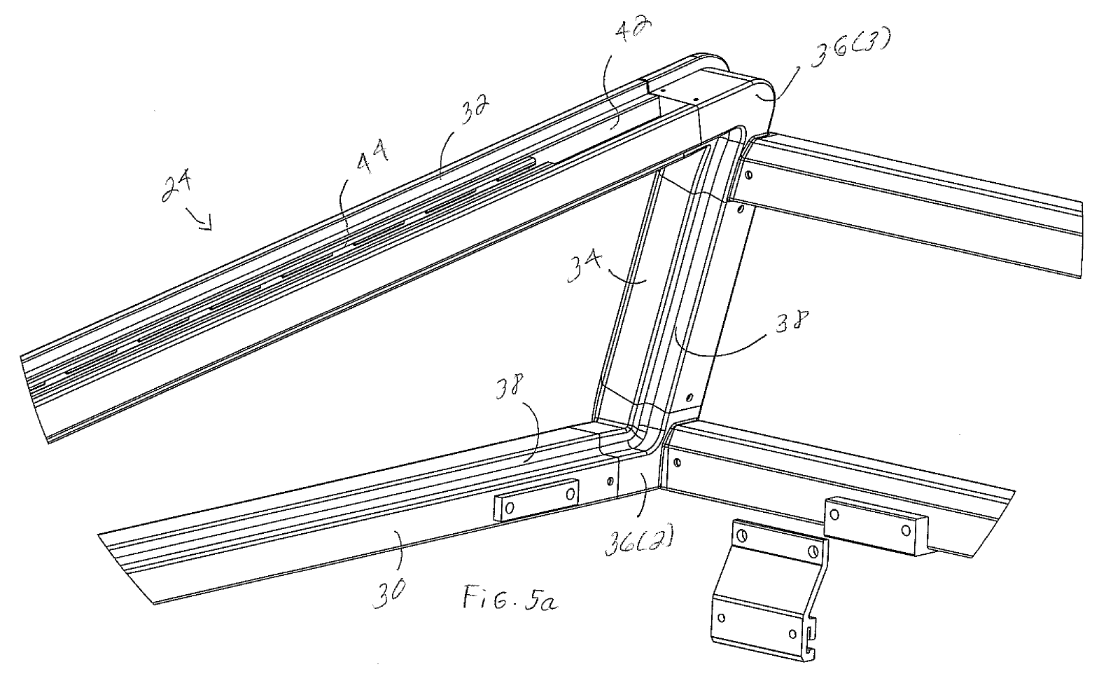

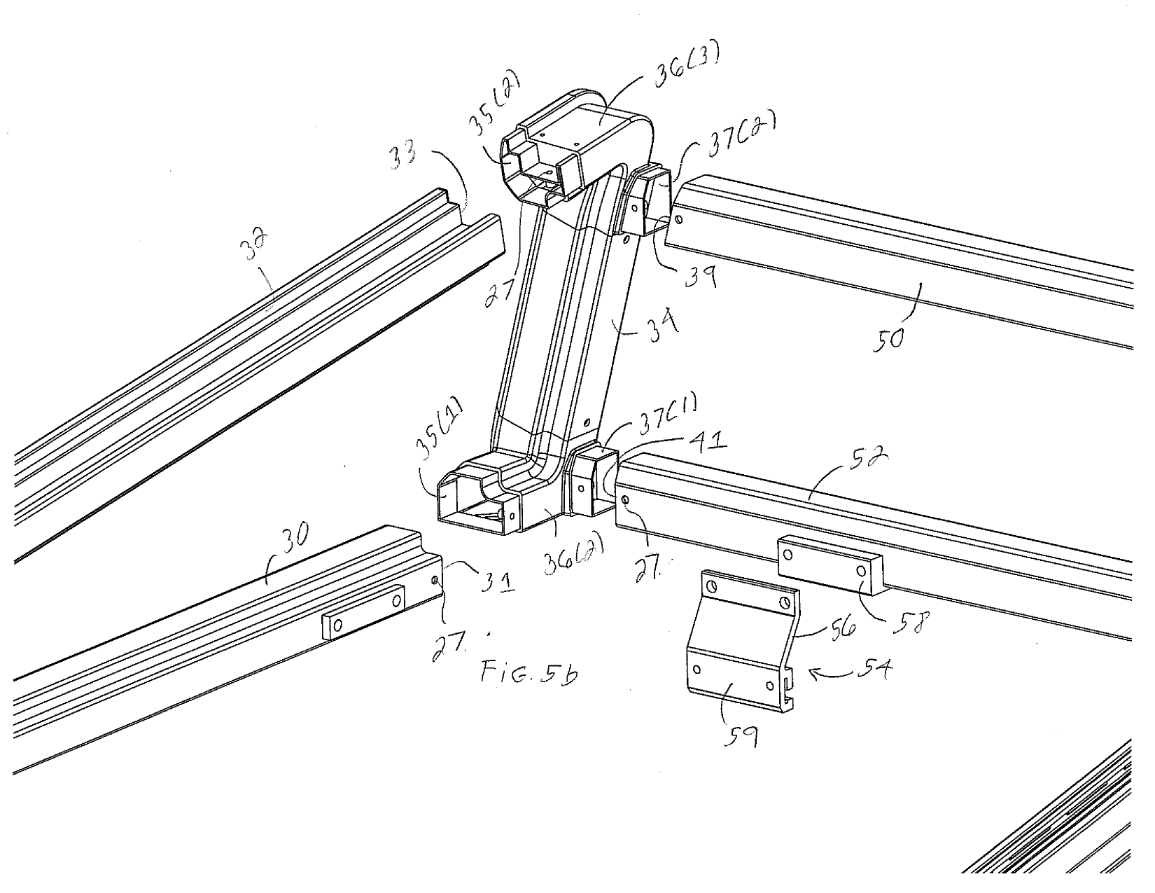

With the above in mind, initial reference is made to FIG. 1 which shows vehicle rack 10 supported on a conventional vehicle in the form of an SUV or pickup 12. Vehicle rack 10 broadly includes a framework 20 which is mounted to at least the left side bed 14 and right side bed 16 of vehicle 12. Attachment to the side beds can be accomplished through a variety of means as well known in the art, and one representative approach is described later with reference to FIG. 5. Indeed, it is common for vehicles of this type to be manufactured with mounting regions to accommodate accessories such as roof racks, toppers, tonneau covers and the like. Accordingly, vehicle rack 10 can be suitably constructed to mate with the accessory mounting regions associated with any of a variety of types of vehicles. Alternatively, the ordinarily skilled artisan would also appreciate that, for those vehicles which may not come factory equipped with such accessory mounting accommodations, vehicle rack 10 could still be suitably constructed as an after-market item to accommodate such capability.

In FIGS. 1 & 2 it may be seen that vehicle rack 10 includes a framework 20 which accommodates a covering, generally 60, and a cargo mounting system 40 shown here in the form of a ski rack. Accordingly, vehicle rack 10 according to this embodiment conveniently provides a means for transporting cargo while also providing a sheltered environment for a portion of the vehicle, namely, its cargo bed.

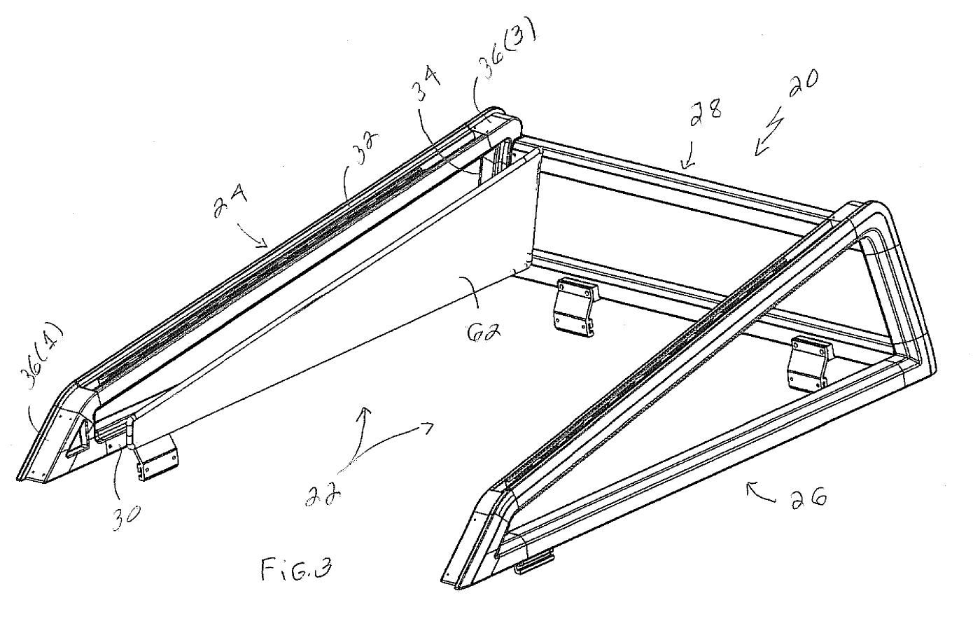

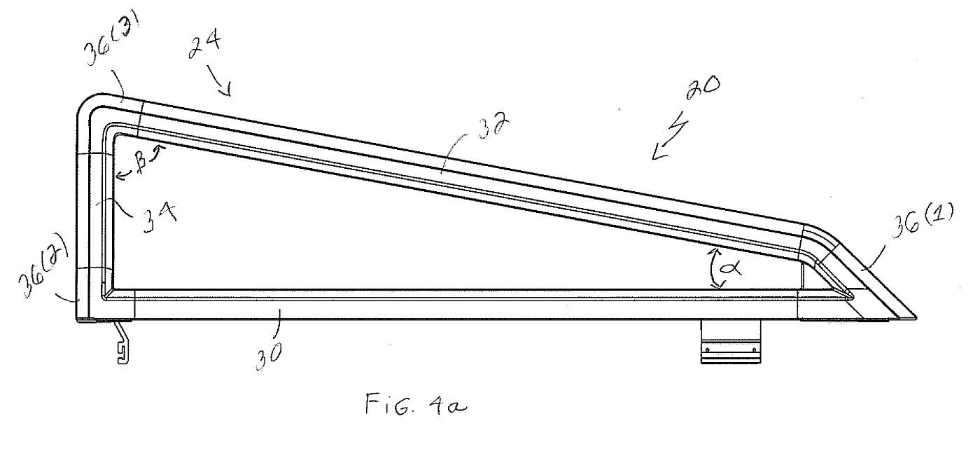

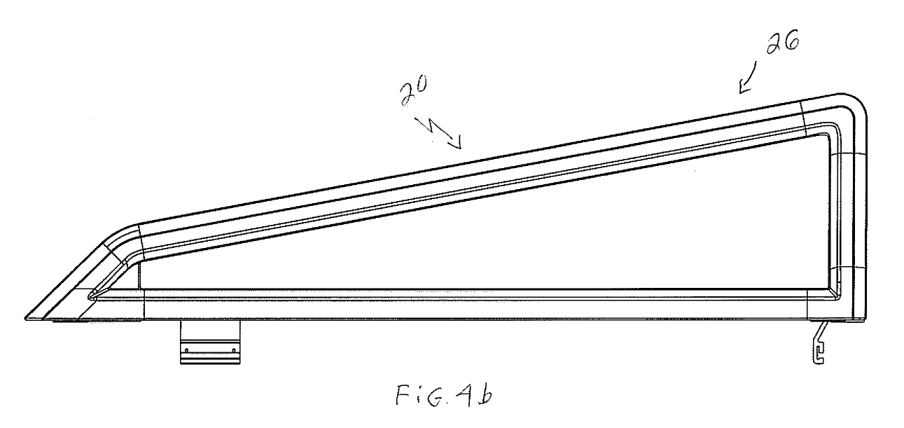

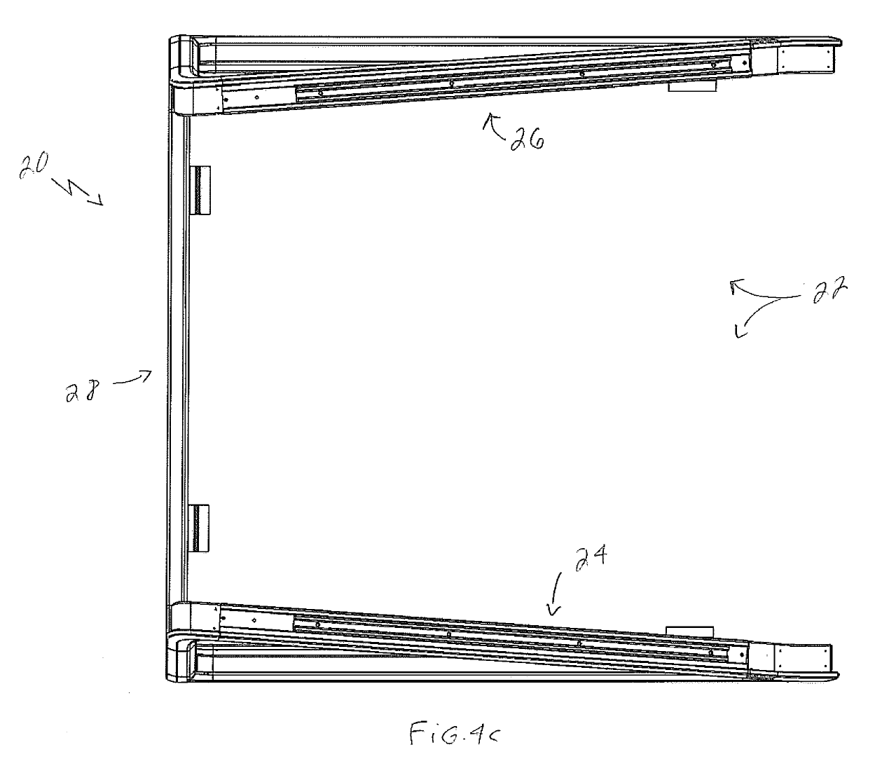

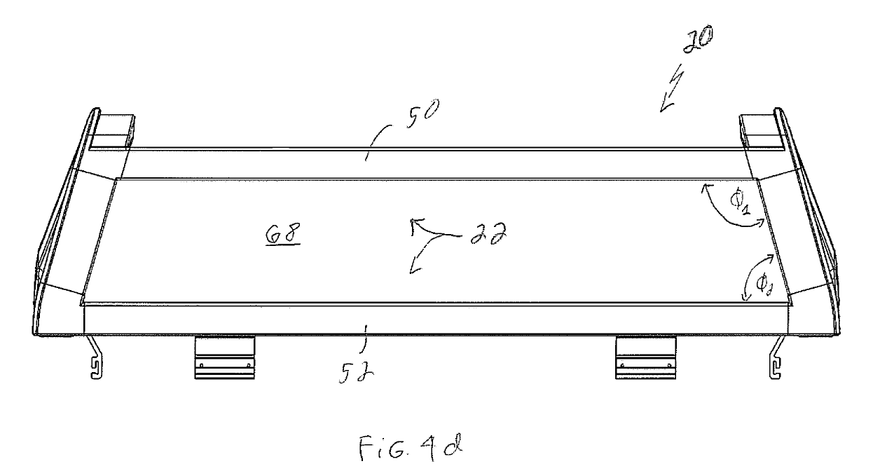

A preferred construction for framework 20 is perhaps best appreciated with reference to FIGS. 3 & 4a-d which show framework 20 without any panels or cargo mounting system disposed thereon. In these figures, it may be seen that framework 20 includes a plurality of connectable frame pieces, generally 22. As can be appreciated from these figures, the left side (or driver's side) portion 24 of framework 20 is a mirror image of the right side (passenger's side) portion 26. The driver's side portion 24 and the passenger's side portion 26 are interconnected and joined by a front framework portion 28 which spans therebetween and faces the cab 15 of the vehicle when in the mounted state shown in FIGS. 1 & 2. As perhaps best appreciated with reference to FIG. 4c, driver's side portion 24 and passenger's side portion 26 may be slanted inwardly so that vehicle rack 10 can have a stylized construction follows the lines of the vehicle's cab. As such, rack 10 has both a functional and aesthetically pleasing characteristics.

The various framework pieces 22 which comprise framework 20 may be manufactured in a variety of different ways. In the various figures the framework pieces 22 comprise extruded, machine cast aluminum so that they are hollow, tubular members. However, the invention should not in any way be limited to such a construction. Indeed, the various framework pieces could be constructed of any of a variety of metals, plastics, or other suitable material. Further, the individual pieces need not be hollow members, and the ordinarily skilled artisan would also readily appreciate that the framework 20 could be formed to comprise one or more integrally molded pieces. For example, each of the driver's side and passenger's side portions 24, 26 and front portion 28 could comprise one or more pieces of integrally molded plastic construction.

Since driver's side portion 24 is constructed as a mirror image of passenger's side portion 26, only one need be described to appreciate their construction. Thus, as shown for example with reference to FIGS. 3 & 4a, driver's side portion 24 includes a lower horizontal tube 30 which extends along the vehicle's left side bed 14, an upper tube 32, an upstanding tube 34, and corner tubes 36(1)-36(3) constructed as end caps. Driver's side portion 24 is generally in the shape of a right triangle with upper tube 32 sloping downwardly and rearwardly towards lower tube 30 at an acute angle “α”. Corner tube 36(1) interconnects these tubes at their rearward ends. Upstanding tube 34 preferably extends at a right angle to lower tube 30 and is joined to it by corner tube 36(2). Upstanding tube 34 joined at another acute angle “β” to upper tube 32 via corner tube 36(3). As shown in the figures, the tubes associated with the driver's side portion 24, as well as those associated with the remainder of framework 20, may be chamfered, beveled, curved or otherwise formed to have an aesthetically pleasing structural design. Further, while the various frame pieces 22 are shown to comprise a common color and material, these tubes could also be varied so that the framework 20, and indeed the vehicle rack 10, is constructed to have an overall aesthetically pleasing design from one or more different materials and/or colors so that it conforms to the style of the vehicle to which it is mounted.

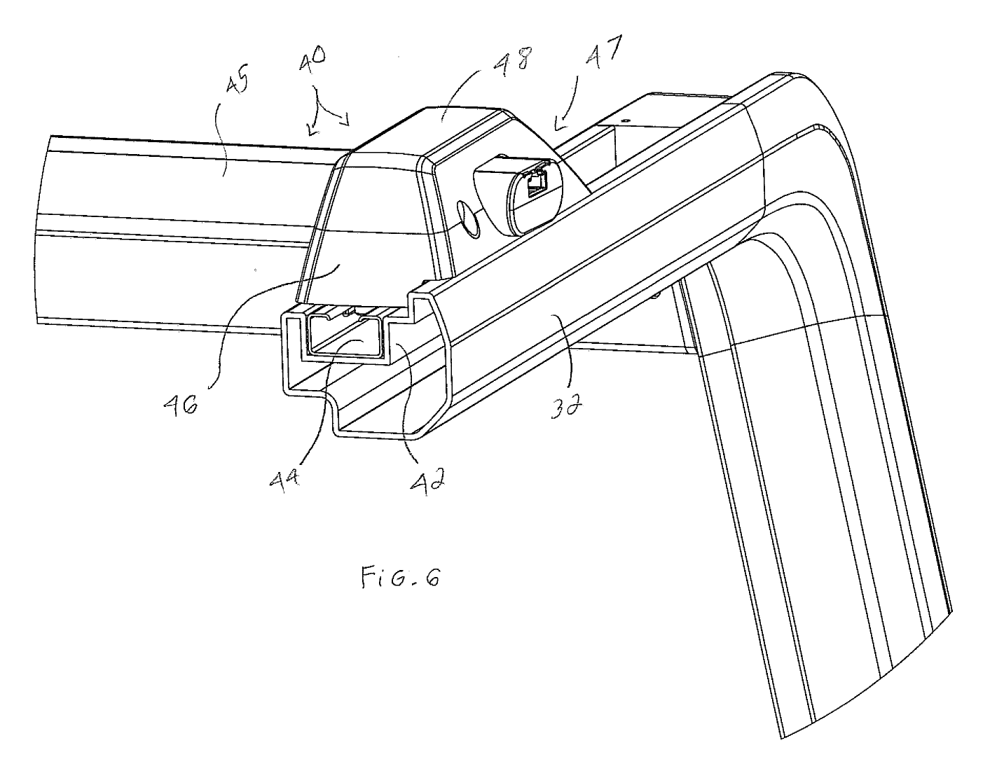

As perhaps best appreciated from FIGS. 3 & 5, the various pieces which comprise driver's side portion 24 may be formed to include an interior surrounding channel, or groove, 38 to accommodate a left side panel 62 which may be removably inserted therein. As such, this left side panel 5, as shown in FIG. 8, is also shaped generally as a right triangle. As perhaps best illustrated in FIGS. 5 & 6 upper tube 32 is formed to include a track 42 having mounting holes for receiving an associated driver's side rail 44 which comprises a component of the cargo mounting system 40. Rail 44 is mounted within track 42 via screw fasteners or the like, or in other known ways. As seen in FIG. 6, rail 44 may accept a bottom clamp piece 46, and bottom clamp piece 46 is configured to attach to an upper clamp piece, or cover, 48 so that a cargo mounting bar 45 may be fastened therebetween in a locked state. Four pairs of clamp pieces or feet, generally 47 (FIGS. 1 & 6) can be employed to attach a pair of mounting bars at selected positions along the lengths of the opposed left and right upper tubes 32, 33 so that cargo such as a snowboard 8 can be mounted thereon. Techniques for accomplishing this are prevalent in the art so that the manner of attaching a cargo mounting system such as 40 need not be described in detail.

FIG. 5 illustrates how various ones of the pieces which comprise driver's side portion 24 may be joined. With an understanding of this construction, the artisan will readily also appreciate that the remainder of the pieces 22 for framework 20 can be attached in similar fashion. With reference then to FIG. 5b, it may be seen that each of the corner pieces 36(2) & (3) includes a plurality of block projections or tabs, generally 35 & 37, respectively. Only two such tabs are shown for each corner piece as the third tabs are concealed by upstanding tube 34. Tabs 35(1) & 35(2), respectively, are insertable into and mate with the open rearward ends 31 and 33 of lower tube 30 and upper tube 32. Each of these members is also provided with a suitable number of screw holes, generally 27, so that they can be fastened together via threaded bolts (not shown). Front portion 28 includes a pair of upper and lower cross tubes, 50 and 52 respectively, which extend transversely to join driver's side portion 24 to passenger's side portion 26. Each of these tubes is also a hollow member and receives respective tab blocks associated with the side portions. For example, tabs 37(1) & 37(2), respectively, are insertable into and mate with the open outer ends 39 and 41 of the front portion upper and lower tubes 50, 52. Again, mounting screws can extend into associated holes formed in these members to retain them in the fastened state. Since, as discussed above, framework 20 may have an inwardly tilted construction, these upper and lower tabs have angled faces, as do the end walls of tubes 50 and 52, so that driver's side portion 24 is mounted relative to front portion 28 at the appropriate acute and obtuse angles “φ₁” and “φ₂” when viewed in a rearward direction as shown in FIG. 4d. Of course, tubes 50 and 52 would be joined to passenger's side portion 26 in similar fashion.

As discussed above, the vehicle rack 10 can be mounted to the vehicle's side beds, or other structural areas, via known means. To this end one or more mounting brackets, such as angle bracket 54, may be provided to interface the framework 20 to the vehicle. Thus, representative angle bracket 44 has an upper portion 56 which is fastened to a resilient block 58 associated with lower tube 52 and a lower portion 59 which can be fastened to the appropriate mounting structure provided on the vehicle's cargo bed. Any suitable number of such mounting block interfaces can be employed as shown in the various figures.

Covering 60 for rack 10 includes a plurality of panels and a cover 66 which provide a sheltered environment for the vehicle's cargo bed 16. Two such panels are included, namely a driver's side panel 62 (FIGS. 1, 3 & 8) and passenger side panel (not shown). The cover 66 for rack 10 includes a front portion 68 (FIG. 4d) which confronts the vehicle's cab and a top portion 70 (FIG. 1) which spans between left side portion 24 and right side portion 26. The panels and the cover may be fabricated from any of a variety of suitable materials such as plastic, vinyl, fabric or the like, and preferably have the characteristic of being weatherproof. It is preferred that these components form a weather tight seal when mounted in the rack 10. Moreover, it is preferred that these components be removable from the vehicle rack without difficulty so that the rack can have a selected modular configuration as determined by a user.

With reference to FIGS. 3 & 8, driver's side panel 62 is triangular in configuration and press fitted into the groove 38 formed within driver's side panel 24 in a close-fitted, friction fit relationship. Side panel 62 includes an interior panel frame 72. Panel frame 72 may be formed by a plurality of bent telescopic tubes, generally 73, or any other suitable type of framing pieces, which are surrounded by a sewn panel shroud 74. The vehicle rack's right side panel is constructed as a mirror image of left side panel 62. While these side panels are shown attached to the rack's framework 20 via press fitting, it is contemplated that they could be attached in other ways suitable for their purposes such as through zipping, snapping, tongue and groove seals, or combinations of the same, etc.

A variety of options are contemplated for forming cover portions 68 and 70. For example, front cover portion 68 could be a multilayered construction similar to the left and right side panels. However, rather than having an interior frame, front cover portion 68 could include an inner rectangular board or other suitable rigid material spanning between upper and lower tubes 50, 52 to provide a reinforced backing. Similarly, top cover a portion 70 could include one or more reinforcement inner boards (rigid panels). Alternatively, each of front cover portion 68 and top cover portion 70 could be flexible segments or ribbed segments. It is also contemplated that top cover portion 70 could be constructed so that it is or fully retractable, or partially retractable at discrete locations between left and right side portions 22, 24. Further, the top cover portion 70 could attach a framework 20 in a variety of ways similar to the left and right side panels.

Accordingly, the present invention has been described with some degree of particularity directed to the exemplary embodiments thereof. It should be appreciated, though, that the present invention is defined by the following claims construed in light of the prior art so that modifications or changes may be made to the exemplary embodiments of the present invention without departing from the inventive concepts contained herein.

What is claimed is:

1. A vehicle rack system, comprising:
a. a framework including a driver's side portion, a passenger's side portion and a front portion extending therebetween, each of said driver's side portion and said passenger's side portion being triangular in configuration and having a lower frame piece for mounting to a side bed of the vehicle and a downwardly sloping upper frame piece; and
b. a covering for providing a sheltered environment for the vehicle's cargo bed, said covering including:
a driver's side panel removably insertable into said driver's side portion;
a passenger's side panel removably insertable into said passenger's side portion; and
a cover spanning between said driver's side portion and said passenger's side portion.

2. A vehicle rack system according to claim 1 wherein said driver's side portion is constructed as a mirror image of said passenger's side portion.

3. A vehicle rack system according to claim 1 including a cargo mounting system removably mounted to said framework.

4. A vehicle rack system according to claim 3 wherein said cargo mounting system includes a driver's side rail received in a first track formed in the upper frame piece of said driver's side portion, a passenger's side rail received in a second track formed in the upper frame piece of said passenger's side portion, and a pair of clamp pieces associated with each for said driver's side rail and said passenger's side rail, said clamp pieces for attaching at least one cargo mounting bar at selected positions along the upper frame pieces of said driver's side portion and said passenger's side portion.

5. A vehicle rack system according to claim 1 wherein said cover includes a front cover portion and a top cover portion.

6. A vehicle rack system according to claim 5 wherein said top cover portion includes a plurality of cover panels.

7. A vehicle rack system according to claim 5 wherein said top cover portion is at least partially retractable at discrete locations between said driver's side portion and said passenger's side portion.

8. A vehicle rack system according to claim 1 wherein the upper frame pieces of said driver's side portion and said passenger's side portion diverge from one another in a rearward direction from said front portion.
